(19) United States
(12) Patent Application Publication
(10) Pub. No.: US 2013/0206321 A1
(43) Pub. Date: Aug. 15, 2013

(54) METHOD AND ASSEMBLY FOR MANUFACTURING A GREEN TYRE

(71) Applicants: Jan Kornelis Grashuis, CG Apeldoorn (NL); Martin De Graaf, KZ Emst (NL); Fredrik Jaap Wemerman, AT Zutphen (NL)

(72) Inventors: Jan Kornelis Grashuis, CG Apeldoorn (NL); Martin De Graaf, KZ Emst (NL); Fredrik Jaap Wemerman, AT Zutphen (NL)

(73) Assignee: VMI HOLLAND B.V., Epe, RK (unknown)

(21) Appl. No.: 13/696,674

(22) PCT Filed: Apr. 14, 2011
(86) PCT No.: PCT/NL11/50254

§ 371 Date: Jan. 9, 2013

Related U.S. Application Data
(60) Provisional application No. 61/345,721, filed on May 18, 2010.

(30) Foreign Application Priority Data
May 18, 2010 (NL) 2004734

(51) Int. Cl. B29D 30/24

(52) U.S. Cl. CPC B29D 30/246
USPC 156/93; 156/110.1; 156/135; 156/396

(57) ABSTRACT

Method and assembly for manufacturing a green tyre using a building drum (1) and a transfer device (3). The method comprises a step of arranging and forming a first tyre component assembly for the green tyre on a building drum (1), a step of placing the transfer device (3) around the building drum, a removal step of the first tyre component assembly for the green tyre being removed from the building drum (1) by the transfer device (3). After the removal step second tyre components for the same green tyre are arranged on the building drum (1), followed by a step of placing the transfer device (3) around the building drum (1), and a step of placing the first tyre component assembly on the second tyre components.

### BACKGROUND OF THE INVENTION

The present invention relates to a method and assembly for manufacturing an unvulcanized or green tyre using a substantially level building drum and a transfer device. The method comprises a step of arranging and forming a first tyre component assembly for the green tyre on a building drum, a step of placing the transfer device around the building drum, and a removal step of the first tyre component assembly for the green tyre being removed from the building drum by the transfer device.

Using several different building drums in the manufacturing of a green tyre and transferring constituent components of the green tyre from a first building drum to a second building drum is for instance known from NL 2001071, US 2010/0000662 and U.S. Pat. No. 7,520,949. The assembly described therein comprises a belt building drum (breaker drum), a carcass building drum, and a shaping drum, wherein each drum is optimised for the part of the manufacturing process for the green tyre to be executed thereon. The assembly described therein further comprises a belt transfer ring and a carcass transfer ring for transferring a belt package and a carcass package, respectively, to the shaping drum for forming the green tyre thereon.

Although the assembly according to NL 2001071 as regards the type of tyre to be manufactured is relatively flexible and has a high production capacity, such an assembly always requires a set of three building drums per tyre size. On assemblies having two different building drums not any wanted tyre structure can be manufactured. Particularly the manufacturing of a green tyre having a so-called sidewall-over-tread (S.O.T.) structure with a high turned up carcass (high ply), wherein the turned up part of the carcass extends to below the belt layer and wherein the sidewall on the one side ends on an edge of the tread, and on the other side is folded around the bead, is impossible on a level building drum.

### SUMMARY OF THE INVENTION

It is an object of the present invention to provide an alternative method, particularly for manufacturing a green tyre having a so-called sidewall-over-tread structure with a high ply.

For that purpose the invention provides a method for manufacturing a green tyre using a building drum and a transfer device of the type mentioned in the preamble characterised in that, after the removal step second tyre components for the same green tyre are arranged on the building drum, followed by a step of placing the transfer device around the building drum, and a step of placing the first tyre component assembly on the second tyre components. The inventor realised that a shaping drum can also be used for manufacturing the carcass as a result of which a separate carcass building drum will no longer be required. However, particularly for the manufacturing of a green tyre having a so-called sidewall-over-tread structure with a high ply, the carcass manufactured has to be temporarily removed from the building drum in order to place rubber sidewalls on the building drum. In that way it becomes possible to turn up both the carcass and the sidewalls individually on the same drum, as a result of which it now becomes possible to manufacture a green tyre having a so-called sidewall-over-tread structure with a high ply on an assembly with only two building drums. For carrying out the turn-up the building drum may be equipped with mechanical arms (levers) as described in WO 01/68356 and/or be equipped with rubber bladders as described in WO 03/013835.

So in one embodiment the first tyre component assembly comprises a carcass package, and the second tyre components comprise a rubber sidewall, which abuts the substantially level drum.

In one embodiment the carcass package is formed by arranging a carcass layer having lateral outer ends on the building drum, placing two beads substantially symmetrically with respect to the centre of the carcass layer near or on the carcass layer, wherein the beads are spaced apart from the lateral outer ends, and turning up the parts of the carcass layer situated between the beads and the lateral outer ends about the beads in the direction of the centre of the carcass layer. This is a first turn-up in the manufacturing process of a green tyre. Preferably use is made of a singular carcass layer (mono-ply).

In one embodiment for manufacturing a green tyre having a belt layer width (b), the distance between the turned up lateral outer ends is smaller than the belt layer width (b). In that way the turned up lateral outer ends will finally extend to below the belt layer, as a result of which at least one sidewall is provided with a double carcass layer. In that way tyres with firmer sidewalls are obtained, with which optionally in case of a flat tyre one is able to drive on (runflat construction).

In one embodiment when placing the, first tyre component on the second tyre component, one of the beads is, at least partially, placed on the rubber sidewall. In that way the rubber sidewall can be placed below the bead area of the carcass package on a level drum.

In a first embodiment the first tyre component assembly further comprises a belt and tread package, wherein the belt and tread package and the carcass package are connected one to the other by placing the belt and tread package substantially coaxially around and spaced apart from the building drum, inflating the carcass package as a result of which the carcass package abuts the belt and tread package, and by means of a stitcher stitching the belt and tread package against the carcass package. An advantage of this embodiment is that for removing the first tyre component it can be engaged at the tread, as a result of which a transfer ring that is known per se can be used for that purpose.

In this embodiment it is advantageous to carry out the turn-up of the carcass layer about the beads, that means the first turn-up in the manufacturing process of a green tyre, after at least the centre section of the carcass layer is at least partially inflated. In that way the carcass layer only needs to be turned up over a smaller angle, particularly smaller than 180 degrees, than is the case in turning up a level carcass layer on a level drum.

In one embodiment the first tyre component assembly comprises a carcass package and belt and tread package in pre-shaped condition that are connected one to the other, wherein the first tyre component assembly in pre-shaped condition is removed from the building drum by the transfer device. In said pre-shaped condition the first tyre component, which preferably is provided with the belt and tread package, has greater firmness, as a result of which it can easily be engaged and handled.

In one embodiment, after the first tyre component has been placed on the second tyre component, the rubber sidewall is turned up against the inflated carcass package. If the belt and tread package is already a part of the first tyre component a green tyre having a sidewall-over-tread structure can thus be manufactured. If the belt and tread package is arranged after turning up the rubber sidewall, a green tyre with a tread-over-sidewall structure can thus be manufactured. The method according to the invention offers great flexibility in the manufacturing of green tyres having highly diverse tyre structures, as a result of which trends in the market can quickly be responded to.

In one embodiment the belt and tread package comprises a tread with edges that run out thin, wherein the rubber sidewall ends on one of the edges of the tread that run out thin, for the manufacturing of a green tyre with a sidewall-over-tread structure.

In a second embodiment, after the carcass package has been placed on the rubber sidewall, the manufacturing of the green tyre further comprises placing the belt and tread package substantially coaxially around and spaced apart from the building drum, inflating the carcass package as a result of which the carcass package abuts the belt and tread package, by means of a stitcher stitching the belt and tread package against the carcass package, and turning up the rubber sidewall against the inflated carcass package. In this embodiment the carcass package is removed from the first building drum in a substantially level condition, and is placed back in said level condition on the rubber sidewalls that have meanwhile been placed on the first building drum.

In one embodiment the belt and tread package comprises a tread having edges that run out thin, wherein the rubber sidewall ends on one of the edges of the tread that run out thin.

As described above, when manufacturing the carcass package the beads are placed spaced apart from the building drum. Prior to or during turning up the carcass layer about the beads the effective diameter of the building drum is enlarged by the building drum members that move to the outside, so that the carcass layer is placed up against the beads. The diameter of the first tyre component, particularly the inner diameter, is substantially defined by the position of the beads.

In one embodiment the diameter of the building drum during the placing of the second tyre components is smaller than the diameter of the first tyre component assembly, and/or at least at the location of the second tyre component the diameter of the building drum is smaller than the inner diameter of the first tyre component assembly. On the one hand this may for instance be effected by moving back the above-mentioned members that move to the outside. On the other hand the substantially level building drum may be provided with recessed parts at the surface of the building drum, in which the second tyre components are placed.

In one embodiment the building drum is active as carcass drum and as shaping drum, and wherein for manufacturing the belt and tread package only one further building drum is provided that is active as belt building drum and as tread building drum. Such a method and a corresponding assembly only require a set of two building drums per tyre size, as a result of which the costs for the assembly can be lower, but also the time for adjusting for adjustment from a first to a second tyre size can be shorter.

According to a further aspect the invention provides an assembly for manufacturing a green tyre using a method as described above, wherein the assembly comprises a transfer device and has only two building drums; a first substantially level building drum that is adapted for being a carcass drum and for being a shaping drum, and a second building drum that is adapted for being a belt building drum and for being a tread building drum, and wherein the transfer device is adapted for temporarily removing the first tyre component assembly for the green tyre from and placing the first tyre component assembly for the green tyre back on the first building drum.

In one embodiment the first and the second building drum are placed next to each other, wherein a centre line of the first building drum and a centre line of the second building drum are in each other's extension. In that way the transfer device for transferring tyre components from the first to the second building drum or vice versa, substantially only needs to take place along one line.

In one embodiment the transfer device is also adapted for being bead positioning device.

In one embodiment the transfer device is also adapted for transferring a belt and tread package from the second building drum to the first building drum.

In one embodiment the transfer device is also adapted for removing the green tyre from the first building drum.

In one embodiment the transfer device is a first transfer device, and the assembly comprises a second transfer device for transferring a belt and tread package from the second building drum to the first building drum.

In one embodiment the second transfer device is also adapted for removing the green tyre from the first building drum. In one embodiment the second transfer device comprises a transfer ring.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

SHORT DESCRIPTION OF THE DRAWINGS

The invention will be elucidated on the basis of a number of exemplary embodiments shown in the attached drawings, in which:

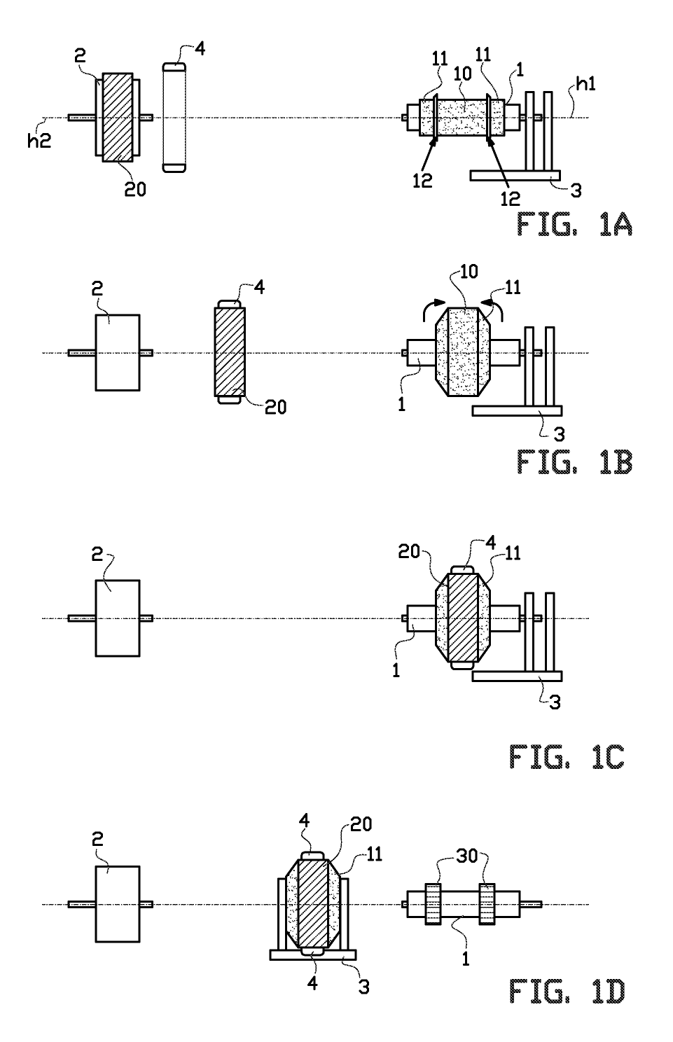

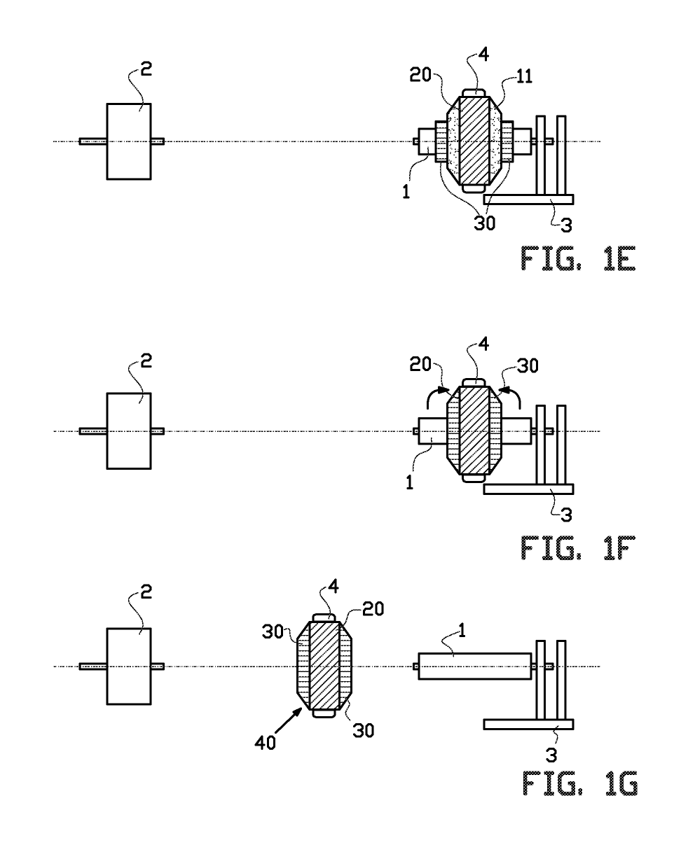

FIGS. 1A-1G show a number of steps of a first exemplary embodiment of a method according to the invention;

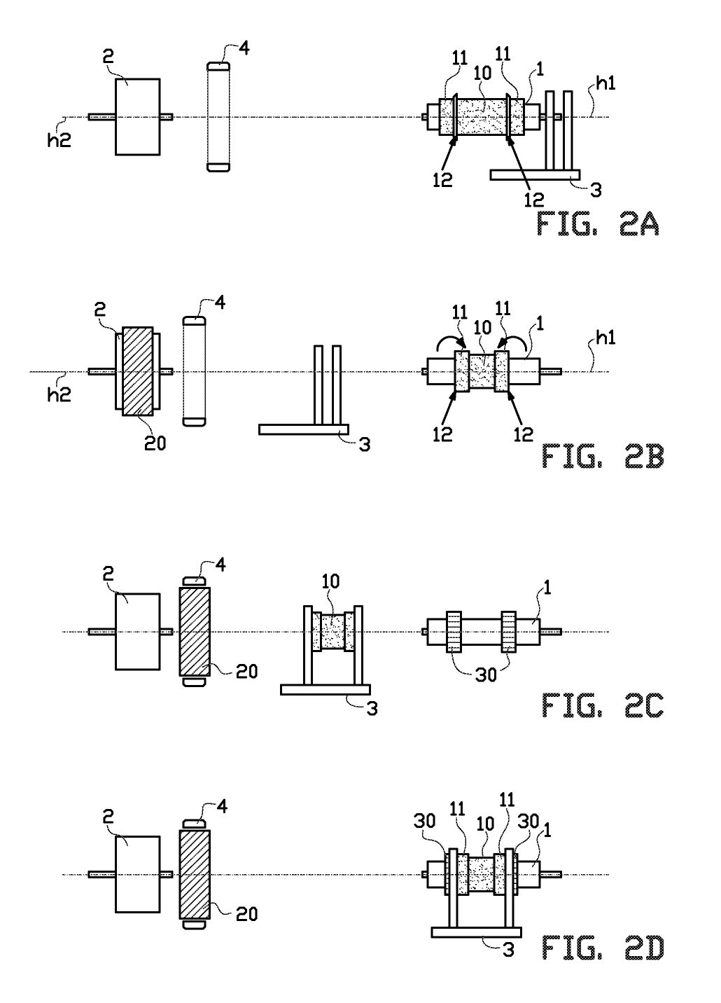

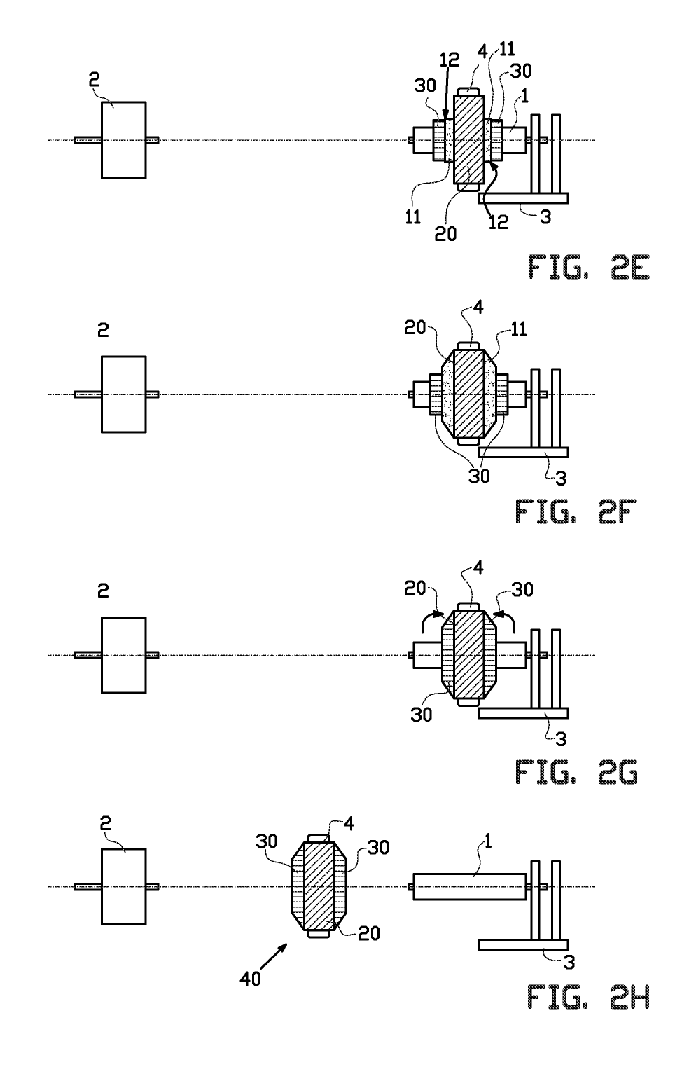

FIGS. 2A-2H show a number of steps of a second exemplary embodiment of a method according to the invention; and

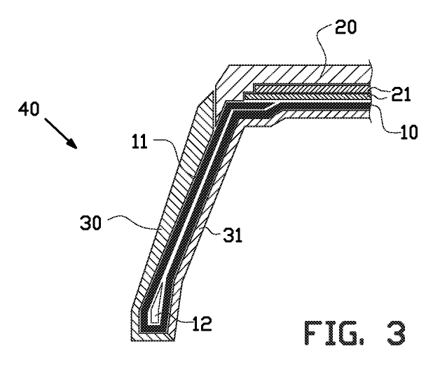

FIG. 3 shows a schematic cross-section of a part of a green tyre having a sidewall-over-tread structure with a high ply.

### DETAILED DESCRIPTION OF THE DRAWINGS

FIG. 1A schematically shows a side view of a device for manufacturing a green tyre. The device is provided with a first building drum 1, a second building drum 2 and a transfer device 3 and a transfer ring 4.

In the shown embodiment the first building drum 1 is a combined carcass and shaping drum (Building and Shaping drum). Said substantially cylindrical building drum 1 having a substantially level outer circumferential surface is provided with a turn-up device that is known per se for turning up edge portions of tyre components arranged on the drum in the direction of the centre of the building drum 1. Said additional turn-up device, as for instance known from patent publication WO 01/68356 which uses radially extending hinging. arms for that purpose, or WO 03/013835 which uses radially expandable inflatable rubber bladders for that purpose, will not be further discussed here so as not to render the subject matter of the invention unnecessarily unclear.

In the embodiment shown the second substantially cylindrical building drum 2 having a substantially level outer circumferential surface, is a combined belt and tread building drum (Breaker and Tread drum), such as for instance known from patent publication WO 2004/045839 or WO 2005/097479.

The first 1 and the second 2 building drum are placed next to each other, wherein a centre line h1 of the first building drum 1 and a centre line h2 of the second building drum 2 are in each other's extension.

A first transfer device 3 movable along the centre line h1, h2 is adapted for engaging and temporarily removing a first tyre component from the first building drum 1. A further second transfer ring 4 movable along the centre line h1, h2 is adapted for engaging a belt and tread package 20 and/or a green tyre 40 at the outer circumference and transporting it substantially along the centre line h1, h2.

Furthermore the device can in a known manner be provided with supply devices for belt layers, tread layers, carcass layers and sidewall layers, and with a bead holder and bead positioning device. Preferably the bead positioning device is adapted for also being active as transfer device 3. Said additional devices will not be further described here so as not to render the subject matter of the invention unnecessarily unclear.

With this device given as example, the first exemplary embodiment of a method according the invention described below can be carried out.

In a manner that is not further described, yet known per se, the method for manufacturing a green tyre comprises a step for arranging a carcass layer 10 on the first building drum 1 and providing beads 12 as shown in FIG. 1A. Subsequently at least the centre area 10 of the carcass is at least partially inflated, after which the edge areas 11 are turned up about the beads 12 in the direction of the centre of the drum 1, as shown in FIG. 1B. This is the first turn-up in the manufacturing process of a green tyre. The carcass package thus formed, near the edges of the carcass package, thus is provided with beads 12 about which the carcass layer 10, 11 has been turned up.

In a manner that is not further described, yet known per se, the method for manufacturing the green tyre comprises a step of arranging belt layers 21 and tread layers 22 on the second building drum 2 for forming a belt and tread package 20. Reference can for instance be made to EP 0 649 730.

As schematically shown in FIG. 1C, subsequently the belt and tread package 20 is engaged by the transfer ring 4 and transferred from the second building drum 2 to the first building drum 1. The belt and tread package 20 is placed substantially coaxially around and spaced apart from the first building drum 1. Subsequently the carcass package 10, 11 is further inflated, as a result of which the carcass package 10, 11 abuts the inner side of the belt and tread package 20. By means of a stitcher (not shown) that is known per se the belt and tread package 20 is stitched against the inflated carcass package 10 for obtaining a mutual bond. Reference can for instance be made to EP 0 627 302.

The first tyre component assembly thus formed, formed by the inflated carcass package with belt and tread package, is engaged in this pre-shaped condition by the transfer device 3, optionally in cooperation with the transfer ring 4, and temporarily removed from the first building drum 1, as schematically shown in FIG. 1D. In that case the tyre is no longer in inflated condition; no pneumatic pressure is exerted anymore on the tyre. Preferably the first tyre component is temporarily parked between the first building drum 1 and the second building drum 2.

Subsequently second tyre components, particularly rubber sidewalls 30, are arranged on the first building drum 1.

Subsequently the first tyre component assembly is placed on the rubber sidewalls 30, wherein the rubber sidewalls 30 extend between the beads 12 and the first building drum 1. In that case the first tyre component assembly is held by means of the transfer ring 4, as schematically shown in FIG. 1E.

Subsequently the rubber sidewalls 30 are turned up against the sidewalls of the once again inflated carcass package 11 with belt and tread package 30 for forming the green tyre 40, as shown in FIG. 1F. This is the second turn-up on the same first drum 1 in this manufacturing process of a green tyre. The green tyre 40 can subsequently be removed from the first building drum 1 by means of the transfer ring 4, as schematically shown in FIG. 1G.

FIG. 2A schematically shows a side view of the same device as shown in FIG. 1A. With this device given as example the method described below can be carried out. With this device given as example the second exemplary embodiment of a method according to the invention described below can be carried out.

As described above in the first exemplary embodiment, a carcass package is formed on the building drum 1, wherein near its edges the carcass package is provided with beads 12, as shown in FIG. 2A. Subsequently the edge areas 11 are turned up about the beads 12 on the substantially level carcass layer 10 in the direction of the centre of the drum 1 as shown in FIG. 2B. This is the first turn-up in the manufacturing process of a green tyre.

Furthermore on the second building drum 2 there are belt layers 21 and tread layers 22, as schematically shown in FIG. 2B for forming a belt and tread package 20.

As schematically shown in FIG. 2C, the belt and tread package 20 is engaged by the transfer ring 4 and removed from the second building drum 2. The first tyre component assembly, in the form of the carcass package 10, 11, in its substantially level condition, is also engaged by the transfer device 3 and temporarily removed from the first building drum 1. Preferably the first tyre component assembly is temporarily parked between the first building drum 1 and the second building drum 2.

Subsequently second tyre components, particularly rubber sidewalls 30, are arranged on the first building drum 1, as schematically shown in FIG. 2C.

Subsequently the first tyre component assembly, that means the carcass package 10, 11 is placed on the rubber sidewalls 30, wherein the rubber sidewalls 30 extend between the bead areas 12 and the first building drum 1, as shown in FIG. 2D.

Furthermore the belt and tread package 20 is placed substantially coaxially around and spaced apart from the first building drum 1, as schematically shown in FIG. 2E.

Subsequently the carcass package 10, 11 is inflated, as a result of which the carcass package 10, 11 abuts the inner side of the belt and tread package 20. By means of a stitcher (not shown) that is known per se, the belt and tread package 20 is stitched against the inflated carcass package 10 for obtaining a mutual bond. In that case the belt and tread package 20 is held by means of the transfer ring 4, as schematically shown in FIG. 2F.

Subsequently the rubber sidewalls 30 are turned up against the sidewalls of the inflated carcass package 11 with belt and tread package 20 for forming the green tyre 40, as shown in FIG. 2G. This is the second turn-up on the same first drum 1 in this manufacturing process of a green tyre. The green tyre 40 can subsequently be removed from the first building drum 1 by means of the transfer ring 4, as schematically shown in FIG. 2H.

By means of the methods described above it is possible a green tyre having a sidewall-over-tread structure with a high ply, as schematically shown in cross-section in FIG. 3. Characteristic of such a green tyre is that the turned-up part of the carcass 11 extends to below the belt layers 21 and to below the tread 22. Furthermore the tread 22 is provided with an edge 23 that runs out thin, wherein the rubber sidewall 30 ends on said edge 23 of the tread 22 that runs out thin, wherein the rubber sidewall 30 extends to below the bead 12. The inner side of the green tyre usually is provided with an inner liner 31.

The above description is included to illustrate the operation of preferred embodiments of the invention and not to limit the scope of the invention. In the exemplary embodiment of the building machine described above and the method according to the invention it is described and shown that the building drums 1, 2 are substantially fixedly positioned and the transfer device 3 and the transfer ring 4 are movable, particularly along the centre line h1, h2. In an alternative embodiment of the building machine and the method according to the invention also the transfer ring 4 and/or the transfer device 3 can be fixedly positioned and the building drums 1, 2 are movable, particularly along the centre line h1, h2.

Starting from the above explanation many variations that fall within the spirit and scope of the present invention, especially as defined in the attached claims, will be evident to an expert.

1. Method for manufacturing a green tyre using a building drum (1) and a transfer device (3), which method comprises:
a step of arranging and forming a first tyre component assembly for the green tyre on a building drum (1),
a step of placing the transfer device (3) around the building drum (1),
a removal step of the first tyre component assembly for the green tyre being removed from the building drum (1) by the transfer device (3),
characterised in that, after the removal step second tyre components for the same green tyre are arranged on the building drum (1), followed by
a step of placing the transfer device (3) around the building drum (1), and
a step of placing the first tyre component assembly on the second tyre components.

2. Method according to claim 1, wherein the first tyre component assembly comprises a carcass package (10), and wherein the second tyre components comprise a rubber sidewall (30), that abuts the substantially level drum.

3. Method according to claim 2, wherein the carcass package (10) is formed by:
arranging a carcass layer (10) having lateral outer ends (11) on the building drum (1),
placing two beads (12) substantially symmetrically with respect to the centre of the carcass layer near or on the carcass layer (10), wherein the beads (12) are spaced apart from the lateral outer ends (11), and
turning up the parts of the carcass layer (10) situated between the beads (12) and the lateral outer ends (11) about the beads (12) in the direction of the centre of the carcass layer.

4. Method according to claim 3 for manufacturing a green tyre having a belt layer width (b), wherein the distance between the turned up lateral outer ends (11) is smaller than the belt layer width (b).

5. Method according to claim 3, wherein when placing the first tyre component assembly on the second tyre component, one of the beads (12) is, at least partially, placed on the rubber sidewall (30).

6. Method according to claim 2, wherein the first tyre component assembly further comprises a belt and tread package (20), wherein the belt and tread package (20) and the carcass package are connected one to the other by:
placing the belt and tread package (20) substantially coaxially around and spaced apart from the building drum (1),
inflating the carcass package (10, 11) as a result of which the carcass package abuts the belt and tread package, and
by means of a stitcher stitching the belt and tread package against the carcass package.

7. Method according to claim 6, wherein the first tyre component assembly comprises a carcass package and belt and tread package in pre-shaped condition that are connected one to the other, wherein the first tyre component assembly in the pre-shaped condition is removed from the building drum by the transfer device.

8. Method according to claim 6, wherein after the first tyre component assembly has been placed on the second tyre component, the rubber sidewall is turned up against the inflated carcass package.

9. Method according to claim 8, wherein the belt and tread package (20) comprises a tread with edges (23) that run out thin, wherein the rubber sidewall (30) ends on one of the edges (23) of the tread that run out thin.

10. Method according to claim 2, wherein after the carcass package has been placed on the rubber sidewall, the manufacturing of the green tyre further comprises:
placing a belt and tread package (20) substantially coaxially around and spaced apart from the building drum (1),
inflating the carcass package (10, 11) as a result of which the carcass package abuts the belt and tread package,
by means of a stitcher stitching the belt and tread package against the carcass package, and
turning up the rubber sidewall (30) against the inflated carcass package (11).

11. Method according to claim 10, wherein the belt and tread package (20) comprises a tread having edges (23) that run out thin, wherein the rubber sidewall (30) ends on one of the edges (23) of the tread that run out thin.

12. Method according to claim 1, wherein the diameter of the building drum during the placing of and/or at the location of the second tyre components is smaller than the internal diameter of the first tyre component assembly.

13. Method according to claim 1, wherein the building drum (1) is active as carcass drum and as shaping drum, and wherein for manufacturing the belt and tread package (20) only one further building drum (2) is provided that is active as belt building drum and as tread building drum.

14. Assembly for manufacturing a green tyre using a method according to claim 1, wherein the assembly comprises a transfer device (3) and has only two building drums (1, 2):
a first building drum (1) that is adapted for being a carcass drum and for being a shaping drum,
a second building drum (2) that is adapted for being a belt building drum and for being a tread building drum, and
wherein the transfer device (3) is adapted for temporarily removing the first tyre component assembly for the green tyre from and placing the first tyre component assembly for the green tyre back on the first building drum (1).

15. Assembly according to claim 14, wherein the first and the second building drum are placed next to each other, wherein a centre line (h1) of the first building drum (1) and a centre line (h2) of the second building drum (h2) are in each other's extension.

16. Assembly according to claim 14, wherein the transfer device is also adapted for transferring a belt and tread package (20) from the second building drum (2) to the first building drum (1).

17. Assembly according to claim 14, wherein the transfer device is also adapted for removing the green tyre from the first building drum (1).

18. Assembly according to claim 14, wherein the transfer device is a first transfer device (3), and wherein the assembly comprises a second transfer device (4) for transferring a belt and tread package (20) from the second building drum (2) to the first building drum (1).

19. Assembly according to claim 18, wherein the second transfer device (4) is also adapted for removing the green tyre from the first building drum (1).

20. Assembly according to claim 18, wherein the second transfer device (4) comprises a transfer ring.

21. Assembly according to claim 14, wherein the transfer device (3) is also adapted for being a bead positioning device.
